(19) United States
(12) Patent Application Publication
(10) Pub. No.: US 2022/0354734 A1
(43) Pub. Date: Nov. 10, 2022

(54) VIBRATORY MASSAGE DEVICE

(71) Applicant: Ann Summers IP Limited, Surrey (GB)

(72) Inventors: Emma BROOKS, Surrey (GB); Elizabeth Jane FIELD, Surrey (GB)

(73) Assignee: Ann Summers IP Limited, Surrey (GB)

(21) Appl. No.: 17/661,879

(22) Filed: May 3, 2022

(30) Foreign Application Priority Data
May 4, 2021 (GB) 2106366.4

(51) Int. Cl. A61H 19/00; A61H 23/02

(52) U.S. Cl. CPC A61H 19/34; A61H 23/0254; A61H 2201/0153; A61H 2201/1463; A61H 2201/5005; A61H 2201/5038

(57) ABSTRACT

The present invention relates to a vibratory massage device, the device comprising; a body portion housing a vibrating source and a power source for powering the vibrating source; wherein the body portion comprises; a first area comprising a slot configured to receive a finger therein, in use; and a second area comprising an elevated contact member for clitoral stimulation; wherein the body portion further comprises a pair of contact arms extending from the first area to the second area.

### CROSS-REFERENCE TO RELATED APPLICATION

This application claims the benefit to GB 2106366.4 filed on May 4, 2021, which is incorporated herein by reference in its entirety.

### FIELD OF THE INVENTION

The present invention relates to a vibratory massage device.

### BACKGROUND TO THE INVENTION

Vibratory massagers and sexual stimulation devices are well known in the art. Such devices have numerous benefits for both mental wellbeing and sexual stimulation.

However, there are a number of problems with known vibratory massaging devices. Many are cumbersome to use, heavy to hold and lack portability, often requiring a direct, wired connection to a power source. Further, many wireless personal massagers lack the power required to provide a strong massage which satisfies the user. Additionally, many personal massagers fail to stimulate more than one region of the body simultaneously, and often focus on direct clitoral stimulation or penetrative stimulation only. For many, this is too intense and detracts from desired effects to be obtained from the device.

By stimulating regions around the clitoral glans, such as the clitoral body, vestibular bulbs, labia minora and labia majora, the user may adopt a layered approach to massage, allowing gradual and adaptable stimulation to be achieved. Further, by providing the user with the choice to stimulate these regions simultaneously or individually, it is more likely that the user will benefit from the effects of the device.

Further, many personal massage devices feel unnatural or uncomfortable to handle and use. A device which feels organic to hold and intuitive to use is advantageous in allowing the user to benefit from the effects of the device.

Objects and aspects of the present claimed invention seek to alleviate at least these problems with the prior art.

### SUMMARY OF THE INVENTION

According to a first aspect of the invention, there is provided a vibratory massage device, the device comprising; a body portion housing a vibrating source and a power source for powering the vibrating source; wherein the body portion comprises; a first area comprising a slot configured to receive a finger therein, in use; and a second area comprising an elevated contact member for clitoral stimulation; wherein the body portion further comprises a pair of contact arms extending from the first area to the second area.

In this way, there is provided a personal massaging device which is intuitive to use, comfortable to hold and stimulates a plurality of regions of the body simultaneously. The device is particularly effective for personal massage and stimulation of body parts such as female genitalia. The user may insert their finger into the slot, allowing the user to simultaneously manually massage the region of the body receiving the massage. The user may hold the device in their hand to massage a part of their body. As such, a distinction is made between the user's hand, which will handle the device during use, and the user's body, which is the part of the user to be massaged, such as their genitalia.

Preferably, the device comprises a channel located between the pair of contact arms and extending from the first area of the body portion. In this way, a lightweight device is provided with a well-defined pair of contact arms. Preferably, the elevated contact member extends into the channel. Preferably, the elevated contact member extends to at least the height of the pair of contact arms. In this way, the elevated contact member is positioned snugly between the pair of contact arms and is elevated for contact with the user's body. As such, the user may bring the elevated contact member into contact with their body without making contact with the pair of contact arms. Preferably, the channel has a substantially U-shaped cross section.

Preferably, the body portion is substantially ovoid in shape. In this way, the device can be held comfortably in the palm of the user's hand, during use. Further, the user may adjust their grip on the device while maintaining comfortable contact with the body portion. The ovoid body portion facilitates smooth movement of the device over the user's body, as the user can rotate their hand gyroscopically to adjust the regions of the device in contact with the body.

Preferably, the slot has a substantially U-shaped cross section. In this way, the slot is configured to accommodate and allow insertion of the user's finger. The user's finger can fit comfortably within the slot, allowing the user to firmly hold the device. In this way, the user has improved control over the pressure and position of the device against the body, allowing the user better control over the location and intensity of massage. The slot further allows the user to adjust their grip on the device with reduced risk of the device slipping or dropping out of their hand. Additionally, the slot allows the user's finger to manually massage the region of the body receiving the massage simultaneously while the device is in contact with the user's body and the massage is occurring. The U-shaped cross section facilitates finger insertion, providing a smooth slot within with the finger can sit. Such a feature is advantageous in improving user pleasure and overall massage experience.

Preferably, the slot extends at least 10% of the length of the device. More preferably, the slot extends at least 20% of the length of the device. Preferably, the slot does not extend more than 50% of the length of the device. More preferably, the slot does not extend more than 40% of the length of the device. In this way, the body portion can rest comfortably within the user's palm, with the user's finger received within the slot. The slot acts as a guide to assist the user in lifting and holding the device, allowing the device to be nested within the user's palm.

Preferably, the elevated contact member comprises an ovoid portion. In this way, the elevated contact member comprises a smooth, curved surface for contact against the user's body, in use. Such a feature is particularly advantageous wherein the device is used for stimulation of the female genitalia. The curved surface of the elevated contact member provides a cushioned region for contact with the clitoral glans during massage. In this way, direct clitoral stimulation can be provided by the device. Further, the elevated contact member can surround the clitoris, providing 270 degree stimulation to the clitoris.

Preferably, the pair of contact arms extend at least 40% of the length of the body portion. More preferably, the pair of contact arms extend at least 50% of the length of the body portion. Still more preferably, the pair of contact arms extend at least 60% of the length of the body portion. In this way, the device is not limited to stimulation of a single region. The contact arms allow for simultaneous stimulation of regions around the clitoral glans, such as the clitoral body, vestibular bulbs, labia minora and labia majora. In some embodiments, the pair of contact arms extend the full length of the body portion. In this way, the pair of contact arms extend substantially the circumference of the device such that there is provided a continuous surface for contact with the user's body.

Preferably, the first area is located at a distal end of the device and the second area is located at the opposing end of the device.

Preferably, the pair of contact arms are curved. This is particularly advantageous for massage of the female genitalia, as the device is shaped to compliment the form and shape of the vaginal region. As such, the user can apply pressure to hold the device against the body without causing discomfort in this region.

Preferably, the pair of contact arms taper towards the first area of the body portion. In this way, the change in width of the contact arm allows a variation of intensity of vibration to be felt along the length of each contact arm. Further, the first area of the body portion tapers towards the slot, guiding the user to cup their hand around the device, in use. Preferably, the portion of each of the pair of contact arms in the first area define the opening of the channel. In this way, the channel separates the pair of contact arms.

Preferably, the maximum separation of the contact arms is less than 60 mm. More preferably, the maximum separation of the contact arms is less than 40 mm. Still more preferably, the maximum separation of the contact arms is less than 30 mm. Preferably, the minimum separation of the contact arms is greater than 10 mm. More preferably, the minimum separation of the contact arms is greater than 14 mm. In this way, the device is compact while allowing for stimulation of a plurality of regions of the user's body simultaneously.

Preferably, the device is substantially symmetrical along a first axis. Preferably, the first axis is the longitudinal axis of the device. In this way, the device can rest comfortably against the body, providing an even massage about the first axis of the device.

Preferably, the vibrating source comprises a motor. The type of motor is not particularly limited and may be any suitable motor for causing the vibrating sources to vibrate within the device. Preferably, the vibrating source comprises a plurality of vibrating sources. Preferably, the vibrating source comprises a vibrating source located in each of the pair of contact arms and in the elevated contact member. In this way, each contact arm and the elevated contact member each provide an individual source of vibrations for massage of the user's body. In this way, the device can produce high power vibrations, directly at the points of the device that contact the regions of the user's body to be massaged.

In some embodiments, the device comprises a body touch detector for detecting the proximity of the device to a user's body. In this way, there is provided a device that automatically changes in operation in response to proximity between the part of the user's body to be massaged and particular locations on the device. Preferably, the body touch detector is configured to detect the proximity of the pair of contact arms and the elevated contact member to a user's body.

Preferably, the at least one vibration source is configured to vibrate only when a portion of one or more of the pair of contact arms or the elevated contact member is in contact with the user's body. In this way, the device is in an active vibration mode only when the device is positioned ready for massage. As such, the user picking up and holding the device in the palm of their hand, without contacting the pair of contact arms or the elevated contact member, will not initiate the at least one vibration source. The user can move the device away from their body, in use, to place the device in an idle mode and immediately cease vibration of the at least one vibration source.

By allowing the user to control vibration of the device through change in contact of the device with their body, the user is able to immediately switch the device from an active vibration mode to an idle mode, such as if vibration becomes too climactic or if the user requires discretion at any point.

Preferably, the body touch detector comprises a plurality of proximity sensors. Preferably, the plurality of proximity sensors are located proximate an external surface of the device. More preferably, the plurality of proximity sensors are located on the pair of contact arms and/or the elevated contact member.

Preferably, the device comprises a shell covering substantially the entire body portion. The shell may comprise any suitable material, such as silicone. In particular, it is envisaged that the shell comprises a semi-flexible, waterproof material. Preferably, the shell is soft. In some embodiments, the shell comprises an inner material and an outer material. For example, the inner material may comprise a foam material for improving the comfort and cushioning of the device against the user's body, in use.

Preferably, the at least one vibrating source is configured to vibrate in a plurality of vibration patterns and/or at a plurality of frequencies. Preferably, the plurality of vibration patterns and/or the plurality of frequencies are predetermined patterns and/or frequencies. Preferably, each vibration source of the at least one vibration source is configured to vibrate at the same pattern and/or frequency as each other at least one vibration source. Alternatively, each vibration source of the at least one vibration source is configured to vibrate in a pattern and/or frequency independent of each other at least one vibration source. The vibration pattern may comprise, for example, continuous vibration, periodic vibration and/or a random vibration pattern.

Preferably, the at least one vibration source is configured to vibrate only when one or more predetermined proximity sensor detects that the device is in contact with a user's body, in use. In some embodiments, every vibration source of the at least one vibration source is configured to vibrate when one or more predetermined proximity sensor detects that the device is in contact with a user's body, in use. In this way, all vibration sources vibrate simultaneously when any proximity sensor is in contact with the user's body. In some embodiments, if only the elevated contact member is in contact with the user's body, only the vibration source within the elevated contact member is configured to vibrate. Preferably, the device comprises a control unit for user control of the vibration patterns and/or frequencies.

Preferably, the power source comprises a rechargeable battery. Preferably, the device comprises a recharging port configured for receipt of a charging lead. Preferably, the device comprises a removably retainable charging lead. The charging lead is not particularly limited, and may be, for example, a USB or pin charging lead. In some embodiments, the device is configured for contactless' charging. Preferably, the shell comprises an aperture for receipt of the charging lead. Preferably, the aperture comprises a sealing member configured to hinder water penetration. In this way, the device can be used and washed without risk of fluid entering internal the shell. In this way, the shell further acts as a waterproof protecting shell for the device. In some embodiments, the power source comprises means for receiving a removable battery element within the device. In this way, a non-rechargeable battery can be received and removed in the device.

In some embodiment, the elevated contact member comprises a groove defining a surface of the elevated contact member. In this way, the elevated contact member is better defined on the device.

### BRIEF DESCRIPTION OF THE DRAWINGS

Embodiments of the present invention will now be described by way of example only and with reference to the accompanying drawings, in which:

FIGS. 1A-1C depict a front, back and side view of a vibratory massage device in accordance with the first aspect of the present claimed invention;

FIGS. 2A and 2B depict a deconstructed view of the vibratory massage device of FIG. 1;

FIG. 3 depicts a second deconstructed view of the vibratory massage device of FIG. 1, connected to a charging member;

FIG. 4 depicts a view of the vibratory massage device of FIG. 1, in use, in the palm of a user's hand; and

FIGS. 5A-5C depict perspective views of a second embodiment of the vibratory massage device in accordance with the first aspect of the present claimed invention.

### DETAILED DESCRIPTION FOR CARRYING OUT THE INVENTION

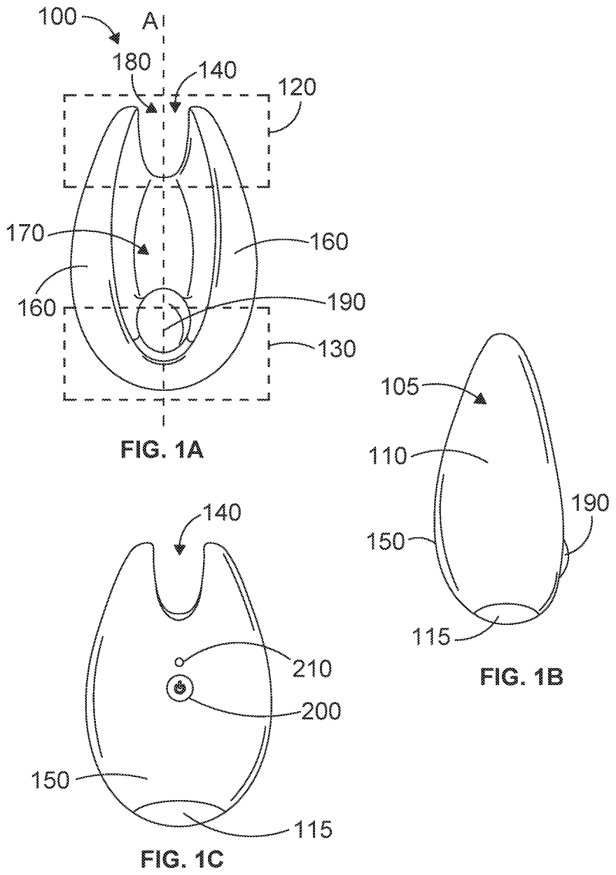

With reference to FIGS. 1A, 1B and 1C, there is illustrated a vibratory massage device 100 in accordance with the first aspect of the present invention. The present invention is directed to a massage device 100 that is particularly effective in stimulating body parts such as female genitalia, however use of the device 100 is not limited to this application.

The vibratory massage device 100 comprises a body portion 110, which is substantially ovoid in shape. The body portion 110 comprises a rigid outer body defining the ovoid shape with a tapered end. The entire body portion 110 is substantially covered by a shell 105. The shell 105 comprises a soft, waterproof silicone material. The shell 105 comprises an aperture located under a sealing member 115 configured to hinder water penetration, located in a first area 120.

The first area 120 of the body portion 110 is located at the tapered end of the ovoid body portion 110 and a second area 130 of the body portion 110 is located at the distal end of the body portion 110. The body portion 110 comprises a palm contact surface 150 extending from the first area 120 to the second area 130. In use, the palm of a user's hand contacts the palm contact surface 150.

The first area 120 comprises a slot 140 configured to receive a finger therein, in use. The slot 140 has a substantially U-shaped cross section, to allow a finger to be received comfortably within the slot 140. The curved cross-section guides the user's finger to rest within the slot 140. The slot 140 extends 25% the length of the device 100, providing the user with a substantial finger hold with which to hold the device 100. In this way, the user can firmly and comfortably hold the device 100, with reduced risk of the device 100 moving or slipping out of their grip.

The slot 140 extends through the entire depth of the device 100 in a direction normal to a first axis A of the device 100, as illustrated in FIGS. 1A and 1C. The first axis A is the longitudinal axis of the device 100.

The body portion 110 further comprises a pair of contact arms 160 extending from the first area 120 to the second area 130. The contact arms 160 extend the length of the body portion 110 and are curved such that the maximum separation between each contact arm 160 is at the centre of the length of the body portion 110, as defined along the first axis A.

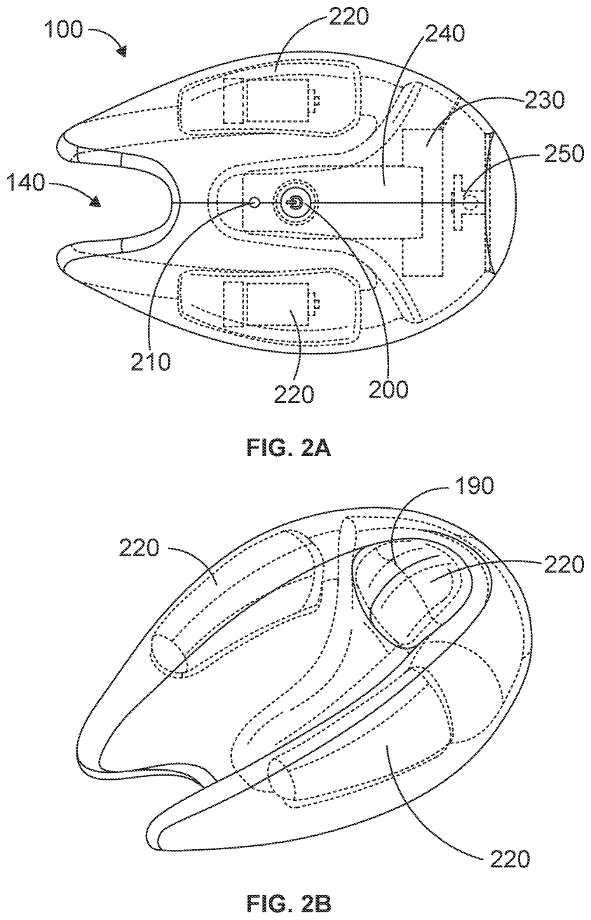

The contact arms 160 taper towards the first area 120 of the body portion 110. The portion of each of the pair of contact arms 160 in the first area 120 define the opening 180 of a channel 170. The channel 170 is located between the pair of contact arms 160 and extends from the first area 120 of the body portion 110 to the second area 130. The channel 170 has a substantially U-shaped cross section, further illustrated in FIG. 2B.

The second area 130 comprises an elevated contact member 190 for clitoral stimulation which extends into the channel 170. The elevated contact member 190 comprises an ovoid portion, which provides a cushioned region for 270 degree contact with the user's clitoral glans during massage. As illustrated in FIG. 1B, the elevated contact member 190 extends above the height of the pair of contact arms 160. In this way, the device 100 can be used for clitoral stimulation only, with only the elevated contact member 190 providing massage to the user's body.

The device 100 further comprises a control module comprising a control button 200 and an indicator light 210 located proximate the control button 200. The indicator light is configured to indicate a plurality of statuses, namely an ON status, wherein the light is on, an OFF status wherein the light is off and a FLASHING status, wherein the light is flashing between on and off. The control button 200 and indicator light 210 are located on the palm contact surface 150, as illustrated on FIG. 1C. In this way, the user can easily access the control button 200 and view the status of the indicator light 210 during use. Further, the risk of accidental actuation of the control button 200 during use is reduced.

The device 100 is substantially symmetrical along the first axis A, thus complimenting the form and shape of the vaginal region.

With reference to FIGS. 2A and 2B, the vibratory massage device 100 comprises a plurality of vibrating sources 220, a rechargeable battery 230, a control unit 240 and a recharging port 250. The battery 230 powers the plurality of vibrating sources 220.

Each vibrating source 220 comprises a tungsten motor. A vibrating source 220 is located within each contact arm 160 and in the elevated contact member 190. In this way, the device 100 comprises three vibration sources 220 to directly massage and stimulate three separate regions of the user's body, in use. Each vibration source 220 is located proximate the surface of the body portion 110 to provide strong vibration to the portion of the user's body in contact with each contact arm 160 and the elevated contact member 190. Each vibrating source 220 is configured to vibrate at volume such that a discrete device 100 is provided.

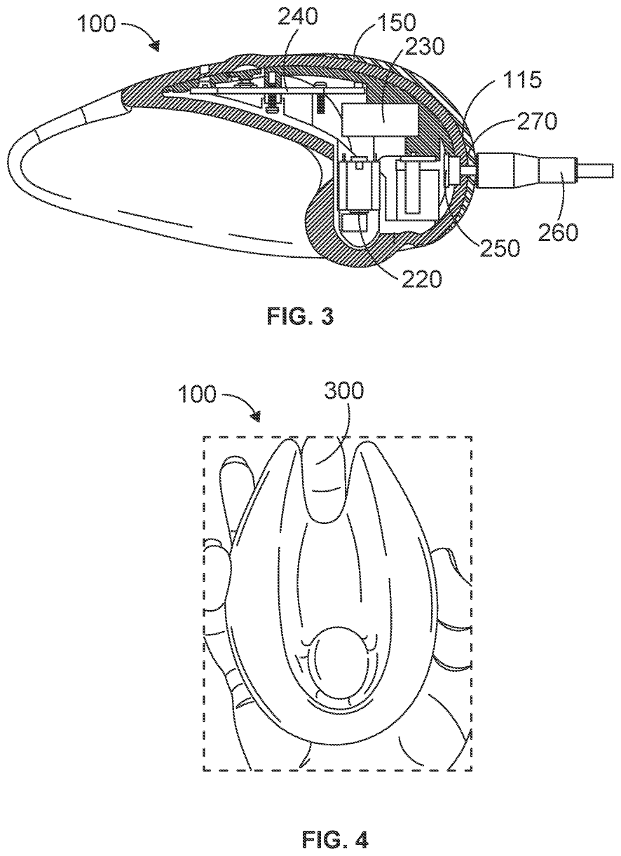

With reference to FIG. 3, the device 100 is shown in electrical connection with a removably retainable charging lead 260. The recharging port 250 is configured for receipt of the charging lead 260. To recharge the battery 230, the charging lead 260 is received in the charging port 250 via an aperture 270 in the body portion 110. The shell 105 covering the body portion 110 comprises a corresponding aperture, such that the charging lead is easily received within the device 100. The aperture in the shell 105 comprises a sealing member, configured to hinder water penetration, for sealing the aperture.

The sealing member 115 comprises a removable cap which may be removed from the device 100 to allow access to the charging port 250. The cap is removably retainable on the device 100 such that the user can reattach the cap when the device 100 is not being charged. In this embodiment, the cap is permanently attached to the shell 105 via a cap retaining member configured to allow partial removal of the cap from the shell, preventing accidental loss or removal of the cap from the device 100. In this way, the shell acts as a waterproof cover to the device 100, protecting the charging port 250 and internal features from accidental fluid damage or other contaminants, such as dust.

The plurality of vibrating sources 220 are configured to vibrate in a plurality of predetermined vibration patterns and at a plurality of frequencies. Each vibration source 220 is configured to vibrate at the same pattern and frequency as each other vibration source 220. In this way, a substantially uniform massage is provided by the device 100. The control unit 240 allows user control of the vibration patterns and/or frequencies. The control button 200 operates under a ‘press and hold’ power control, wherein the user presses down and holds the control button 200 to turn on, and then turn off, the device 100. The status of the indicator light 210 indicates to the user the mode of the device. The user then presses the control button 200 to switch between each vibration patterns and/or frequencies. In this way, a simple user interface with a single control button 200 is provided. In some embodiments, the device 100 comprises a plurality of control buttons configured to switch the device 100 between the vibration patterns and/or frequencies.

As illustrated in FIG. 4, the slot 140 allows the user's finger 300 to manually massage the region of the body receiving the massage, while the device 100 is in contact with the user's body and the massage is occurring. Additionally, the slot 140 allows for finger 300 insertion during massage when the device 100 is used for vaginal stimulation. As outlined above, there is provided a lightweight device 100 which can be nestled comfortable in the user's palm, during use.

For vaginal stimulation, in use, the elevated contact member 190 can be cushioned against the user's glans clitoris and the pair of contact arms 160 surround the inner area of the clitoris, namely the clitoral body and vestibular bulbs, and the outer area of the vulva. In this way, the device complements the shape and form of the female genitalia, specifically the shape of the clitoral organ and vulva.

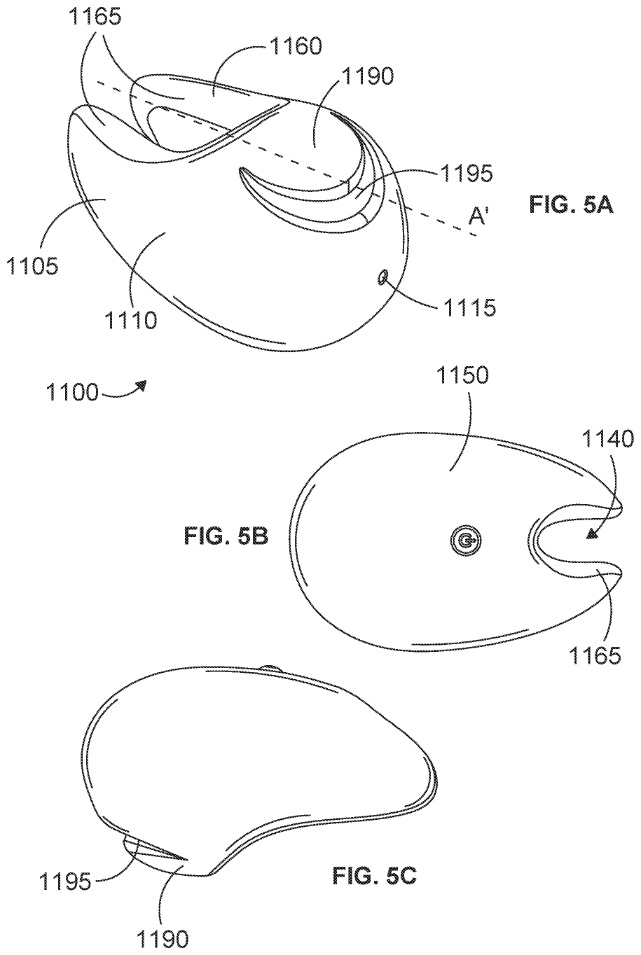

With reference to FIGS. 5A-5C, there is illustrated a second embodiment of the vibratory massage device 1100 in accordance with the first aspect of the present claimed invention. In the following description, similar numerals will be used for similar parts of the first and second embodiments. The device 1100 of FIGS. 5A-5C is similar to the device 100 of FIGS. 1A-1C with the following differences.

The device 1100 comprises a pair of contact arms 1160 and a slot 1140. The pair of contact arms 1160 comprise a continuous surface 1165 extending along each contact arm 1160, along the tapered end of each contact arm 1160 and meets the palm contact surface 1150. The continuous surface 1165 is a continuous, smooth surface. In this way, each contact arm 1160 comprises a dedicated smooth surface for contact with the user's body during use, and the device 1100 is better contoured to body parts such as the female genitalia.

The elevated contact member 1190 comprises a groove 1195 defining a surface of the elevated contact member 1190, distal the pair of contact arms 1160. In this embodiment, the groove 1195 is crescent shaped and is symmetrical about the first axis A′ of the device 1100. The groove 1195 distinguishes the elevated contact member 1190 from the body portion 1110. The body portion 1110 is also configured such that the elevated contact member 1190 is elevated for contact with the user's body, as shown in FIG. 5C.

The sealing member 1115 comprises a ‘self-healing’ aperture to allow access to the charging port. In use, the user applies a force to push the charging lead through the sealing member 1115 to charge the device 1100. When the user removes the charging lead, the sealing member 1115 is configured to automatically form a seal configured to hinder water penetration once again.

The device 1100 further comprises a body touch detector for detecting the proximity of the device 1100 to a user's body. The body touch detector comprises a plurality of proximity sensors located proximate an external surface of the body portion 1110. The shell 1105 is configured such that contact with the user's body is transferred through the shell 1105 to the plurality of proximity sensors. The plurality of proximity sensors are located on the pair of contact arms 1160 and the elevated contact member 1190.

When switched on, the device 100 assumes an idle mode unless and until a user's body part comes into close proximity with one of the proximity sensors. Upon detecting contact of the pair of contact arms 1160 and/or the elevated contact member 1190 to the user's body, an active vibration mode is initiated without further user input. In the active vibration mode, the plurality of vibrating sources of the device 1100 vibrate simultaneously. In this way, the plurality of vibration sources are configured to vibrate only when a portion of one or both of the pair of contact arms 1160 or the elevated contact member 1190 is in contact with the user's body. The user can move the device 1100 out of contact with their body to place the device 1100 in an idle mode, immediately ceasing vibration of the plurality of vibration sources.

The dimensions of the device 1100 (in mm) are illustrated on FIGS. 5B and 5C. The slot 1140 extends 28.3 mm, approximately 26% the length of the device 1100. The contact arms are 68 mm in length, and extend approximately 64% of the length of the device. The minimum separation of the contact arms 1160 is 14.2 mm.

It will be appreciated that the above described embodiments of the first aspect of the present invention are given by way of example only, and that various modifications may be made to the embodiments without departing from the scope of the invention as defined in the appended claims.

1. A vibratory massage device, the device comprising;
a body portion housing a vibrating source and a power source for powering the vibrating source;
wherein the body portion comprises;
a first area comprising a slot configured to receive a finger therein, in use; and
a second area comprising an elevated contact member for clitoral stimulation;
wherein the body portion further comprises a pair of contact arms extending from the first area to the second area.

2. The device of claim 1, wherein the device comprises a channel located between the pair of contact arms and extending from the first area of the body portion.

3. The device of claim 2, wherein the elevated contact member extends into the channel.

4. The device of any one of claim 2 or 3, wherein the channel has a substantially U-shaped cross section.

5. The device of any one preceding claim, wherein the body portion is substantially ovoid in shape.

6. The device of any one preceding claim, wherein the slot has a substantially U-shaped cross section.

7. The device of claim 6, wherein the slot extends at least 10% of the length of the device.

8. The device of any one preceding claim, wherein the elevated contact member comprises an ovoid portion.

9. The device of any one preceding claim, wherein the pair of contact arms extend at least 50% of the length of the body portion.

10. The device of any one preceding claim, wherein the pair of contact arms are curved.

11. The device of any one preceding claim, wherein the pair of contact arms taper towards the first area of the body portion.

12. The device of any one of claims 2 to 11, wherein the portion of each of the pair of contact arms in the first area define the opening of the channel.

13. The device of any one preceding claim, wherein the maximum separation of the contact arms is less than 40 mm.

14. The device of any one preceding claim, wherein the device is substantially symmetrical along a first axis.

15. The device of any one preceding claim, wherein the vibrating source comprises a motor.

16. The device of any one preceding claim, wherein the vibrating source comprises a plurality of vibrating sources.

17. The device of claim 16, wherein the vibrating source comprises a vibrating source located in each of the pair of contact arms and in the elevated contact member.

18. The device of any one preceding claim, wherein the elevated contact member extends to at least the height of the pair of contact arms.

19. The device of any one preceding claim, wherein the elevated contact member comprises an ovoid portion.

20. The device of any one preceding claim, wherein the elevated contact member comprises a groove defining a surface of the elevated contact member.

21. The device of any one preceding claim, wherein the device comprises a shell covering substantially the entire body portion.

22. The device of any one preceding claim, wherein the at least one vibrating source is configured to vibrate in a plurality of vibration patterns and/or at a plurality of frequencies.

23. The device of claim 22, wherein the device comprises a control unit for user control of the vibration patterns and/or frequencies.

24. The device of any one preceding claim, wherein the power source comprises a rechargeable battery.
